(19) United States
(12) Patent Application Publication
(10) Pub. No.: US 2023/0335756 A1
(43) Pub. Date: Oct. 19, 2023

(54) ELECTRODE FOR MEMBRANE-ELECTRODE ASSEMBLY WITH LOW IONOMER CONTENT AND HIGH OXYGEN PERMEABILITY AND MANUFACTURING METHOD THEREOF

(71) Applicants: HYUNDAI MOTOR COMPANY, Seoul (KR); KIA CORPORATION, Seoul (KR)

(72) Inventors: Young Jung Heo, Hwaseong-si (KR); Il Seok Chae, Seoul (KR)

(21) Appl. No.: 18/082,801

(22) Filed: Dec. 16, 2022

(30) Foreign Application Priority Data
Apr. 15, 2022 (KR) 10-2022-0046623

(51) Int. Cl. H01M 4/86; H01M 4/90; H01M 4/88

(52) U.S. Cl. CPC H01M 4/8663; H01M 4/9075; H01M 4/8825

(57) ABSTRACT

An electrode for a membrane-electrode assembly having improved oxygen permeability by reducing the ionomer content includes a catalyst including a support and an active metal supported on the support, an ionomer, and an additive including a carbon material and a proton conductive functional group bonded to the carbon material.

### CROSS REFERENCE TO RELATED APPLICATIONS

The present application claims priority to Korean Patent Application No. 10-2022-0046623, filed Apr. 15, 2022, the entire contents of which is incorporated herein for all purposes by this reference.

### BACKGROUND

### 1. Field

The present disclosure relates to an electrode for a membrane-electrode assembly having improved oxygen permeability by reducing the ionomer content and a manufacturing method thereof.

### 2. Description of the Related Art

The electrode of a proton exchange membrane fuel cell (PEMFC) includes a catalyst in which platinum is supported on a support and an ionomer as a binder.

Ionomers conduct protons. As the ionomer, a perfluorinated polymer such as Nafion is mainly used. However, because perfluorinated polymers are expensive and not good for the environment, there are many attempts to reduce the use thereof. However, the content of the ionomer in the electrode is a very important factor related to the performance of the fuel cell.

On the other hand, when the content of the ionomer in the electrode is large, the ionomer blocks the gas diffusion path, thereby slowing the diffusion rate of oxygen in the electrode so that the performance of the fuel cell may be deteriorated. In order to increase the gas permeability of the electrode, an ionomer has been proposed in which a functional group such as a sulfonic acid group is introduced into a polymer having a high free volume. However, the introduction of the functional group may cause a decrease in molecular weight of the ionomer and, at the same time, may denature the ionomer, thereby exhibiting inappropriate physical properties as a binder. The above studies have limitations in terms of the problem of satisfying the proper molecular weight of the polymer and the improvement of free volume and oxygen permeability, so a new solution is needed.

### SUMMARY

An objective of the present disclosure is to provide an electrode for a membrane-electrode assembly having an improved oxygen diffusion rate and a manufacturing method thereof.

The objective of the present disclosure is not limited to the objective mentioned above. The objectives of the present disclosure will become more apparent from the following description and will be realized by means and combinations thereof described in the claims.

An electrode for a membrane-electrode assembly, according to an embodiment of the present disclosure, may include a catalyst including a support and an active metal supported on the support, and an additive including a carbon material and a proton conductive functional group bonded to the carbon material.

The carbon material may include at least one selected from the group consisting of activated carbon, carbon black, carbon nanotubes, carbon fibers, graphene, and combinations thereof.

The proton conductive functional group may be bonded to the surface of the carbon material.

The proton conductive functional group may include a compound represented by Formula 1 below.

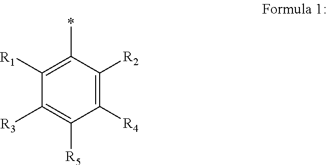

Where, * is a connection site to the carbon material, and at least one of R1 to R5 may include a sulfonic acid group, a phosphoric acid group, or a carboxyl group, and the remaining of R1 to R5 each independently may include hydrogen or an alkyl group having 1 to 4 carbon atoms.

The electrode may include about 3 to 30 parts by weight of the additive with respect to 100 parts by weight of the catalyst.

The electrode may further include about 5 to 50 parts by weight of an ionomer with respect to 100 parts by weight of the catalyst.

A manufacturing method for an electrode for a membrane-electrode assembly according to an embodiment of the present disclosure may include preparing a dispersion containing a carbon material, adding an aromatic hydrocarbon to the dispersion and reacting the carbon material with the aromatic hydrocarbon to obtain an intermediate, preparing an additive comprising the carbon material and a proton conductive functional group bonded to the carbon material by treating the intermediate with an acid solution containing at least one selected from the group consisting of sulfuric acid, phosphoric acid, carboxylic acid, and combinations thereof, preparing a coating solution comprising a catalyst and the additive, wherein the catalyst comprises a support and an active metal supported on the support, and forming an electrode by applying the coating solution on a substrate.

The aromatic hydrocarbon may include at least one selected from the group consisting of benzoyl peroxide, chlorobenzene, naphthalene, and combinations thereof.

The aromatic hydrocarbon may be added in an amount of about 100 to 300 parts by weight with respect to 100 parts by weight of the carbon material.

The intermediate may be treated with the acid solution at about 80° C. to 200° C. and about 5 to 48 hours.

According to the present disclosure, an electrode for a membrane-electrode assembly having an improved oxygen diffusion rate and a method for manufacturing the same may be obtained.

The effects of the present disclosure are not limited to the effects mentioned above. It should be understood that the effects of the present disclosure include all effects that can be inferred from the following description.

### BRIEF DESCRIPTION OF THE FIGURES

FIG. 1 shows a membrane-electrode assembly according to the present disclosure.

### DETAILED DESCRIPTION

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, the terms “include” or “have” should be understood to designate that one or more of the described features, numbers, steps, operations, components, or combinations thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where another part is in the middle. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values, and/or expressions in which such numbers essentially occur in obtaining such values, among others. Since they are approximations reflecting various uncertainties in the measurement, it should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integers, including the minimum value to the maximum value containing the maximum value, are included unless otherwise indicated.

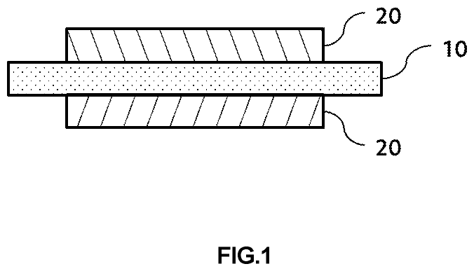

FIG. 1 shows a membrane-electrode assembly according to the present disclosure. The membrane-electrode assembly may include an electrolyte membrane 10 and a pair of electrodes 20 disposed on both sides of the electrolyte membrane 10.

The electrolyte membrane 10 may include a proton conductive polymer. For example, the electrolyte membrane 10 may include a perfluorinated sulfonic acid-based polymer such as Nafion.

The electrode 20 may include a catalyst, an ionomer, and an additive.

The catalyst may include a support and an active metal supported on the support.

The type of the support is not particularly limited but may include, for example, at least one selected from the group consisting of carbon black, carbon nanotubes, graphite, graphene, carbon fiber, carbon nanowire, and combinations thereof.

The type of the active metal is not particularly limited but may include, for example, precious metals such as platinum (Pt), palladium (Pd), iridium (Ir), and ruthenium (Ru). In addition, the active metal may further include a transition metal such as copper (Cu), cobalt (Co), nickel (Ni), and iron (Fe). The active metal may include a mixture of the precious metal and the transition metal or an alloy thereof.

The ionomer may conduct protons and provide adhesion force to the catalyst, additive, and the like. The proton may mean a hydrogen ion. The ionomer may include a perfluorinated sulfonic acid-based polymer such as Nafion.

Since the ionomer blocks the diffusion path of the gas in the electrode 20 to slow the diffusion rate of oxygen, it is preferable to use the ionomer as little as possible. Accordingly, the present disclosure is characterized in that the content of the ionomer is reduced in order to increase the diffusion rate of oxygen in the electrode 20, and the additive is used instead.

The additive may have a form in which the proton conductive functional group is bonded to the surface of the carbon material. Specifically, the proton conductive functional group may be bonded to the surface of the carbon material.

The carbon material may include at least one selected from the group consisting of activated carbon, carbon black, carbon nanotubes, carbon fiber, graphene, and combinations thereof.

Since the surface of the carbon material is chemically stable, if a functional group such as a sulfonic acid group, a phosphoric acid group, or a carboxyl group is directly substituted, the degree of substitution is not high, and the effect of adding the additive may be insignificant. Accordingly, the present disclosure is characterized in that the content of the proton conductive functional group of the additive is increased by primarily treating the surface of the carbon material with an aromatic hydrocarbon and then attaching the proton conductive functional group such as a sulfonic acid group to the aromatic hydrocarbon. As the content of the proton conductive functional group increases, high proton conductivity may be secured even with a small amount of the additive. A method for producing the additive will be described later.

The proton conductive functional group may be represented by the following Formula 1.

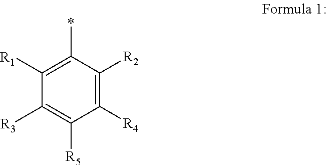

where, * is a connection site to the carbon material.

At least one of R1 to R5 may include a sulfonic acid group, a phosphoric acid group, or a carboxyl group, and the remaining of R1 to R5 may independently include hydrogen or an alkyl group having 1 to 4 carbon atoms.

It is preferable that at least one of R1 to R5 may include a sulfonic acid group, and the additive may include a sulfur (S) element in an amount of 0.1 to 20 at % as a result of X-ray photoelectron spectroscopy (XPS) analysis on a surface thereof. When the content of the element sulfur (S) falls within the above numerical range, high proton conductivity can be achieved even with a small amount of additive.

The electrode 20 may include an amount of about 5 to 50 parts by weight of the ionomer and an amount of about 3 to 30 parts by weight of the additive based on 100 parts by weight of the catalyst. When the content of the additive is less than 3 parts by weight, the effect of improving proton conductivity according to the addition of the additive may be insignificant. When the content of the additive exceeds 30 parts by weight, the electrode 20 may be thickened and the reaction area of the catalyst may be reduced, and thus the performance of the membrane-electrode assembly may have deteriorated. When the content of the ionomer is less than 5 parts by weight, it may be difficult for the electrode 20 to maintain its shape, and the mechanical properties of the electrode 20 may have deteriorated. When the content of the ionomer exceeds 50 parts by weight, the resistance of material transfer in the electrode 20 is too high, and thus the oxygen diffusion rate may decrease.

A method for manufacturing an electrode for a membrane-electrode assembly according to the present disclosure may include preparing a dispersion containing a carbon material, adding an aromatic hydrocarbon to the dispersion and reacting the carbon material with the aromatic hydrocarbon to obtain an intermediate, preparing an additive comprising the carbon material and a proton conductive functional group bonded to the carbon material by treating the intermediate with an acid solution containing at least one selected from the group consisting of sulfuric acid, phosphoric acid, carboxylic acid, and combinations thereof, preparing a coating solution including the catalyst, the ionomer, and the additive; and forming an electrode by applying the coating solution on a substrate.

The dispersion may be prepared by adding and stirring the carbon material to an organic solvent such as dimethyl sulfoxide.

A surface-treated carbon material may be obtained by adding about 100 to 300 parts by weight of the aromatic hydrocarbon to the dispersion with respect to 100 parts by weight of the carbon material and reacting under specific temperature and time conditions.

When the amount of the aromatic hydrocarbon is less than 100 parts by weight, the degree of surface treatment of the carbon material is insignificant, and thus the proton conductive functional group may not be sufficiently bonded to the surface of the carbon material. When the amount of the aromatic hydrocarbon exceeds 300 parts by weight, a side reaction may occur due to an excess of reactants.

The aromatic hydrocarbon may include at least one selected from the group consisting of benzoyl peroxide, chlorobenzene, naphthalene, and combinations thereof.

The reaction of the carbon material and the aromatic hydrocarbon may be performed at about 80° C. to 200° C. for about 5 to 48 hours to obtain the intermediate. After the reaction is completed, the intermediate can be obtained by drying and filtration.

The intermediate may be one in which a functional group, including an aromatic hydrocarbon such as a phenyl group, is bonded to the surface of the carbon material.

Thereafter, the intermediate may be treated with an acid solution. Through this, a sulfonic acid group, a phosphoric acid group, or a carboxyl group may be substituted for the phenyl group, and an additive may be obtained by bonding the proton conductive functional group represented by Formula 1 above to the surface of the carbon material.

After the intermediate is added to the acid solution, the intermediate may be processed at about 80° C. to 200° C. for about 5 to 48 hours to obtain the additive. When the temperature is less than 80° C. or the time is less than 5 hours, the intermediate and the acid solution may not react. When the temperature exceeds 200° C. or the time exceeds 48 hours, the intermediate may be thermally decomposed to decrease the yield.

After preparing a coating solution by adding and stirring the additive, catalyst, and ionomer to a solvent, the coating solution is applied on a substrate and dried to form an electrode. The solvent is not particularly limited, and any solvent may be used as long as the solvent may uniformly disperse the solvent without reacting with additives, catalysts, and ionomers. For example, the solvent may include a mixed solvent of ethanol and distilled water.

The electrode may have a loading amount of the active metal of 0.05 mg/cm² to 0.5 mg/cm². However, the loading amount of the active metal is not limited thereto and may be appropriately adjusted in consideration of the desired performance of the fuel cell.

A membrane-electrode assembly may be prepared by attaching the electrodes prepared as described above to both sides of the electrolyte membrane. The method of attaching the electrode is not particularly limited, and any method commonly used in the technical field to which the present disclosure pertains may be applied.

The present disclosure will be described in more detail with reference to the following examples. However, the following examples are merely examples to help the understanding of the present disclosure, and the scope of the present disclosure is not limited thereto.

### Example 1

A dispersion was prepared by adding and stirring 1 g of carbon material to 100 ml of dimethyl sulfoxide as an organic solvent.

After raising the temperature of the dispersion to about 100° C., 3 g of benzoyl peroxide, an aromatic hydrocarbon, was added and reacted for 24 hours. The resulting product was filtered and dried to obtain an intermediate.

The intermediate was added to 40 ml of concentrated sulfuric acid with a concentration of 98% as an acid solution and stirred, then transferred to a Teflon container and placed in a high-temperature and high-pressure reactor. The additive was obtained by reacting at about 120° C. for about 12 hours. The additive includes a proton conductive functional group represented by the following Formula 1, in which at least one of R1 to R5 is a sulfonic acid group, and the remaining of R1 to R5 is hydrogen, respectively.

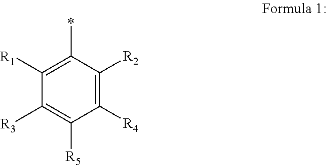

### Example 2

An additive was prepared in the same manner as in Example 1, except that the carbon material being performed with surface treatment was added to the acid solution and then reacted for about 24 hours, and an electrode was prepared using the same.

### Comparative Example 1

The same carbon material itself as in Example 1 was set as Comparative Example 1.

### Comparative Example 2

The same carbon material as in Example 1 was added to concentrated sulfuric acid, having a concentration of 98%, and reacted under conditions of 80° C. and 12 hours to obtain an additive. That is, in Comparative Example 2, a sulfonic acid group was directly substituted for a carbon material that was not surface-treated.

Table 1 below shows the results of XPS analysis of the surfaces of the additives according to Examples 1, 2, and Comparative Examples 1 and 2.

TABLE 1

| | Comparative | | Comparative | | | | | |
|---|---|---|---|---|---|---|---|---|
| Element type | Example 1 | | Example 2 | | Example 1 | | Example 2 | |
| Carbon (C) | 91.3 | at % | 86.8 | at % | 82.9 | at % | 78.8 | at % |
| Oxygen (O) | 8.1 | at % | 11.3 | at % | 13.6 | at % | 15.7 | at % |
| Sulfur (S) | — | | 1.2 | at % | 2.8 | at % | 4.6 | at % |
| Etc. | 0.6 | at % | 0.7 | at % | 0.7 | at % | 0.9 | at % |

In Comparative Example 1, since the proton conductive functional group was not substituted, the element sulfur (S) was not detected. In Comparative Example 2, a sulfonic acid group is directly bonded to a carbon material that has not been subjected to surface treatment, and the content of elemental sulfur (S) is very low compared to Examples 1 and 2.

As in Examples 1 and 2, it can be seen that the degree of sulfonation can be greatly increased by processing the surface of the carbon material with an aromatic hydrocarbon and then bonding a sulfonic acid group thereto.

### Examples 3 to 5

A catalyst, an ionomer, and the additive, according to Example 2 in the amounts shown in Table 2 below, were added to a mixed solvent of ethanol and distilled water and stirred to obtain a coating solution. The coating solution was applied on a substrate and dried at about 80° C. to prepare an electrode.

### Comparative Example 3

An electrode was prepared in the same manner as in Example 3, except that no additives were added, and catalysts and ionomers were used in the amounts shown in Table 2 below.

Table 2 below is a measurement of the oxygen permeation amount of the electrodes according to Examples 3 to 5 and Comparative Example 3. Each electrode was placed on the micropore support layer film at 25° C. and no humidification conditions, and the amount of oxygen permeation was measured.

TABLE 2

| | Catalyst | Additive | Ionomer | |
|---|---|---|---|---|
| | content | content | content | Oxygen |
| | [parts by | [parts by | [parts by | Permeation |
| Division | weight] | weight] | weight] | [GPU]^{One)} |
| Comparative | 100 | 0 | 30 | 30 |
| Example 3 | | | | |
| Example 3 | 100 | 10 | 10 | 2,400 |
| Example 4 | 100 | 20 | 10 | 2,100 |
| Example 5 | 100 | 10 | 15 | 825 |

^{One)}1 [GPU] = 1 × 10⁻⁶ cm³, STP (273K, 1 atm)

It can be seen that the oxygen permeation amount of Example 3 is significantly higher than the oxygen permeation amount of Comparative Example 3. Through this, it can be confirmed that the oxygen permeability of the electrode can be greatly increased according to the present disclosure.

As described above in detail, the scope of the present disclosure is not limited to the experimental examples and embodiments, and various modifications and improvements of those skilled in the art defined in the following claims are also included in the scope of the present disclosure.

1. An electrode for a membrane-electrode assembly, the electrode comprising:
a catalyst comprising a support and an active metal supported on the support; and
an additive comprising a carbon material and a proton conductive functional group bonded to the carbon material.

2. The electrode of claim 1, wherein the carbon material comprises at least one of activated carbon, carbon black, carbon nanotubes, carbon fiber, graphene, or any combination thereof.

3. The electrode of claim 1, wherein the proton conductive functional group is bonded to the surface of the carbon material.

4. The electrode of claim 1, wherein the proton conductive functional group is represented by: 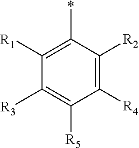
wherein * is a connection site to the carbon material,
at least one of R1 to R5 comprises a sulfonic acid group, a phosphoric acid group, or a carboxyl group, and the remaining of R1 to R5 each independently comprises hydrogen or an alkyl group having 1 to 4 carbon atoms.

5. The electrode of claim 1, wherein the electrode comprises the additive in an amount of about 3 to 30 parts by weight based on 100 parts by weight of the catalyst.

6. The electrode of claim 1, wherein the electrode further comprises an ionomer in an amount of about 5 to 50 parts by weight based on 100 parts by weight of the catalyst.

7. The electrode of claim 1, wherein the proton conductive function group comprises sulfonic acid group, and the additive comprises a sulfur (S) element in an amount of 0.1 to 20 at %.

8. A manufacturing method for an electrode for a membrane-electrode assembly, the method comprising:
preparing a dispersion comprising a carbon material;
adding an aromatic hydrocarbon to the dispersion and reacting the carbon material with the aromatic hydrocarbon to obtain an intermediate;
preparing an additive comprising the carbon material and a proton conductive functional group bonded to the carbon material by treating the intermediate with an acid solution comprising at least one of sulfuric acid, phosphoric acid, carboxylic acid or any combination thereof;
preparing a coating solution comprising a catalyst and the additive, wherein the catalyst comprises a support and an active metal supported on the support; and
forming an electrode by applying the coating solution on a substrate.

9. The method of claim 8, wherein the carbon material comprises at least one of activated carbon, carbon black, carbon nanotubes, carbon fiber, graphene or any combination thereof.

10. The method of claim 8, wherein the aromatic hydrocarbon comprises at least one of benzoyl peroxide, chlorobenzene, naphthalene or any combination thereof.

11. The method of claim 8, wherein about 100 to 300 parts by weight of the aromatic hydrocarbon is added with respect to 100 parts by weight of the carbon material.

12. The method of claim 8, wherein the intermediate is treated with the acid solution under the conditions at a temperature of about 80° C. to 200° C. for about 5 to 48 hours.

13. The method of claim 8, wherein the proton conductive functional group is bonded to the surface of the carbon material.

14. The method of claim 8, wherein the proton conductive functional group is represented by: 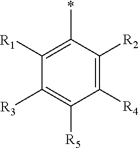
wherein * is a connection site to the carbon material,
at least one of R1 to R5 comprises a sulfonic acid group, a phosphoric acid group, or a carboxyl group, and
the remaining of R1 to R5 each independently comprises hydrogen or an alkyl group having 1 to 4 carbon atoms.

15. The method of claim 8, wherein the electrode comprises the additive in an amount of about 3 to 30 parts by weight based on 100 parts by weight of the catalyst.

16. The method of claim 8, wherein the electrode further comprises an ionomer in an amount of about 5 to 50 parts by weight based on 100 parts by weight of the catalyst.

17. The method of claim 8, wherein the proton conductive function group comprises sulfonic acid group, and the additive comprises a sulfur (S) element in an amount of 0.1 to 20 at %.
